(19) United States
(12) Patent Application Publication
(10) Pub. No.: US 2003/0015667 A1
(43) Pub. Date: Jan. 23, 2003

(54) Curing unit

(76) Inventors: Joseph A. MacDougald, Madison, CT (US); Daniel P. Clark, Stamford, CT (US); Weitao Jia, Wallingford, CT (US); George Zychek, Stamford, CT (US)

Correspondence Address: PENTRON CORPORATION, 53 NORTH PLAINS INDUSTRIAL ROAD, WALLINGFORD, CT, 06492, US

(21) Appl. No.: 10/199,748

(22) Filed: Jul. 18, 2002

Related U.S. Application Data
(63) Continuation-in-part of application No. 09/464,804, filed on Dec. 17, 1999.
Application No. 09/464,804 is a continuation-in-part of application No. 09/310,603, filed on May 12, 1999, now abandoned.

(51) Int. Cl. A61C 19/00

(52) U.S. Cl. 250/455.11

(57) ABSTRACT

A curing/whitening unit provides a light guide and a conduit for delivering a source of cooling fluid to or near the surface being cured as radiant energy of a light beam is directed on the material to be cured. An outlet for the cooling fluid is provided integral the curing unit proximate the outlet or tip of the light guide of the curing unit to provide simultaneous cooling fluid to the mouth as curing or whitening is occurring.

### CROSS-REFERENCE TO RELATED APPLICATIONS

This application is a continuation-in-part application of U.S. patent application Ser. No. 09/464,804, filed Dec. 17, 1999, which is a continuation-in-part application of U.S. patent application Ser. No. 09/310,603 filed on May 12, 1999, all which are hereby incorporated by reference.

### FIELD OF THE INVENTION

The invention is directed to a light curing unit for curing photocurable dental material.

### BACKGROUND OF THE INVENTION

Photocurable dental materials are cured when exposed to radiant energy in preselected spectral ranges in either the visible or ultraviolet spectrum. The radiant energy used to cure the materials is typically transmitted from a lamp through an optic light guide. In order to maximize the output of the light energy, the tip of the light guide is usually positioned as close as possible to the photocurable material in the dental restoration. The amount of time to effect curing of materials placed directly in the mouth is typically from about one (1) to about one hundred eighty (180) seconds depending upon the material being used and the intensity of the light being used. Furthermore, the surface area of the material to be cured may be larger than the tip of the light guide or the beam of the light directed on the material such that the beam must be moved along the surface of the material, curing the material in segments instead of in one single moment, increasing the time for curing. The longer the curing time, the longer the exposure of the light beam to surfaces in the mouth. Effects from the exposure of heat from the beam directed in the mouth can occur from inexperienced practitioners or operators of curing lights by inaccurately focusing the beam in the mouth or prolonging the length of time the beam is focused in the mouth, causing damage to gums and/or pulp tissue and eventually causing the loss of a tooth or teeth. One way of relieving the effects of the heat produced by the intensity of the light beam during the curing process could be to simultaneously spray or squirt cool air or water into the patient's mouth. Unfortunately, it may not be practicable or possible for the dentist to hold an air or water gun in addition to the light curing apparatus and aim accurately at the desired location with both instruments. Typically, a dentist performs a function with one instrument only, and subsequently performs a second function with a different instrument due to the precision required and the difficult working space involved.

U.S. Pat. No. 5,803,729 to Tsimerman is directed to a curing light for dental filling materials and includes a water filled chamber between a light source and a concentrator element. The water acts as a filter to filter out light in the infrared portion of the spectrum and also cools the concentrator protecting it from the damaging effects of a large light source. The cooling effects are directed to the components of the curing light and not to the surface of the material being cured or area surrounding the material being cured.

U.S. Pat. No. 4,756,597 to Hahn et al. is directed to a light guide used in medical instruments such as endoscopes. The light guide comprises fiber surrounded by a gas tube that cools the tip of the light guide fiber. This is necessary because the guide itself may come into contact with surfaces of the human body which are being examined. The light guide is not used for curing and does not emit high intensity light as does a curing unit. Therefore, the light guide is not concerned with the surfaces proximate the material undergoing curing and the effects of the radiant energy being emitted. The invention is only concerned with keeping the surface of the tip of the light guide cool.

There is a need for a light curing unit that mitigates the effects of the heat on the tissues in the mouth as a result of the intensity of the light from the light guide. It is beneficial to provide a curing unit that can ease and facilitate the process of curing. It is desirable to provide a curing unit having a cooling mechanism for soothing the tissues in the mouth while simultaneously curing dental resin materials therein.

### SUMMARY OF THE INVENTION

The above-discussed and other drawbacks and deficiencies of the prior art are overcome or alleviated by the curing unit herein which provides a light guide and a conduit for delivering a source of cooling fluid to or near the surface being cured as radiant energy of a light beam is directed on the material to be cured. An outlet for the cooling fluid is provided integral the curing unit proximate the outlet or tip of the light guide of the curing unit to provide simultaneous cooling fluid to the mouth as curing is occurring.

The curing unit comprises a lamp source and power supply for delivering power thereto whereby the lamp supplies light to the light guide. One or more filters may be provided proximate the lamp source to limit the band width to that effective for curing dental materials. A cooling mechanism is provided in the unit for supplying cooling fluid to and/or proximate the surface which is being cured to diminish the effects of the light on surrounding tissue in the mouth. The curing unit may also be used for bleaching or whitening of teeth and other similar processes. The curing unit allows a dentist to cure photoactivated material in the mouth and cool the surfaces in the mouth simultaneously with a single instrument.

The curing unit may include a secondary power light source to “target” the surface to be cured before the main light source is turned on. This assists the operator in accurately aiming the light guide toward the surface to be cured in an otherwise dark, small area. The secondary light source may be any known light source such as a laser or an LED.

### BRIEF DESCRIPTION OF THE DRAWINGS

Features of the present invention are disclosed in the accompanying drawings, wherein similar reference characters denote similar elements throughout the several views, and wherein:

FIG. 1 is perspective view of the curing light partially showing the internal componentry therein;

FIG. 2 is a cross-sectional view of the light guide of the curing unit of FIG. 1;

FIG. 3 is a cross-sectional view of an alternate embodiment of the light guide of the curing unit herein;

FIG. 4 is a cross-sectional view of an alternate embodiment of the light guide of the curing unit herein;

FIG. 5 is a cross-sectional view of an alternate embodiment of the light guide of the curing unit herein;

FIG. 6 is a cross-sectional view of an alternate embodiment of the light guide of the curing unit herein;

FIG. 7 is a diagrammatic view of a fluid flow sensor circuit for the curing unit herein; and

FIG. 8 is a perspective view of the light guide positioned proximate a tooth.

### DETAILED DESCRIPTION OF THE INVENTION

The present invention is directed to a curing unit having a hand held light guide for curing photoactivated dental restorative materials, resins, composites, coatings and the like such as ALERT® condensable composite available from Jeneric/Pentron Inc., Wallingford, Conn. The unit may also be used for other procedures such as tooth whitening.

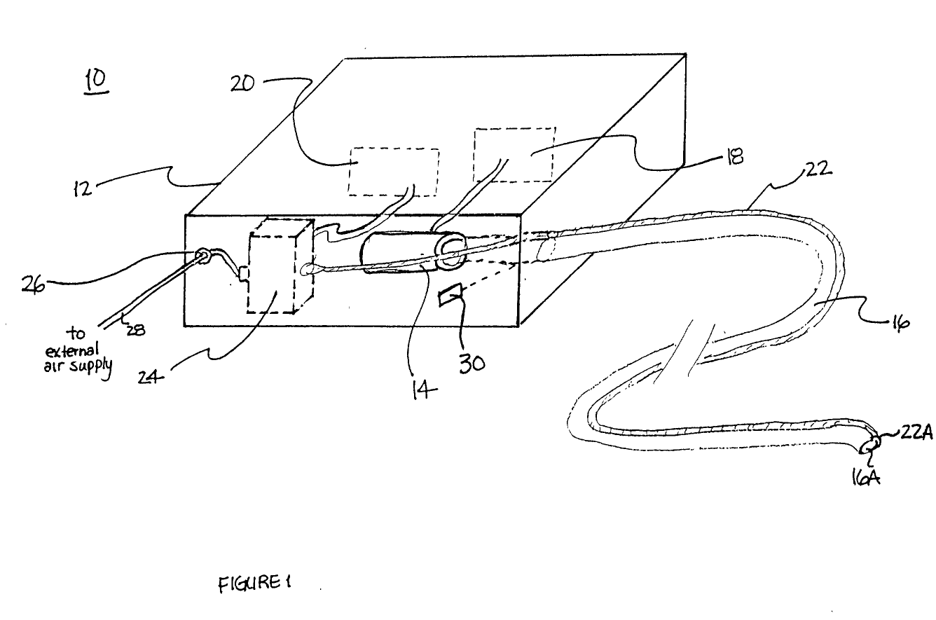

FIG. 1 is directed to a curing unit 10 having a housing 12 containing a light source 14 therein. Light source 14 supplies radiant energy to a light guide 16 and may be any light source such as a tungsten, halogen, mercury vapor, short arc xenon, metal halide or the like depending on the desired spectral bandwidth of radiant energy. Housing 12 may also include a power supply 18 for supplying power to light source 14 and a control circuit 20. One or more filters are included proximate light source 14 to achieve the desired bandpass of light to light guide 16. The desired bandwidth for curing dental materials is typically carried out in the UV/visible light range, i.e., from about 350 to about 700 nanometers (nM) and preferably between about 400 to about 550 (nM). Preferably, the materials are cured in the visible light range. The common photoinitiator in light cured dental materials is camphorquinone. Its peak absorption of light is at about 468 nM. Light guide 16 may be a fiber optic light guide, a liquid filled light guide or the like. The invention is not limited to the construction or composition of the guide. The light beam is emitted at opening 17 of guide 16.

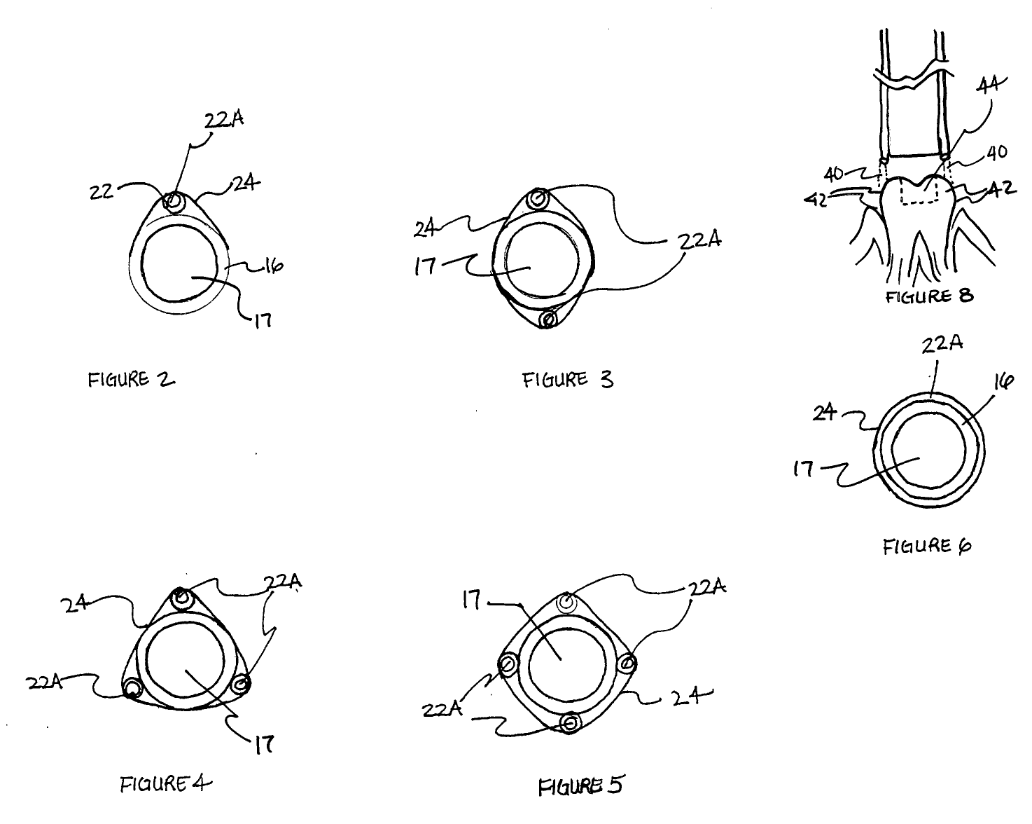

A cooling mechanism may be included in the unit. The cooling mechanism is used to provide a cooling fluid to cool the surface which is being cured by the light exiting the light guide and/or to cool areas proximate the surface which are effected by the intensity of the light. Preferably, the cooling mechanism supplies a cooling medium in the form of a fluid such as a gas or a liquid including, but not limited to air, inert gas (e.g., argon, nitrogen) and water which is dispersed on and/or proximate the surface being cured. The fluid is supplied in a hose or conduit 22 disposed proximate light guide 16 and having an outlet proximate the light guide. FIG. 1 shows hose 22 disposed along guide 16 with outlet end 22A terminating with outlet end 16A of guide 16. The light beam is emitted at opening 17. FIGS. 2 through 6 show variations of cross-sectional views of guide 16 and hose 22 wherein a sheath or cover 24 encases guide 16 and hose 22. Preferably, sheath 24 is a thermal plastic insulation material such as polyvinyl chloride.

Guide 16 may include a plurality of tubes 22 to provide a plurality of cooling outlets 22A from tube or tubes 22 which disperse the cooling medium, e.g., air, more equally on the surface(s) being effected by the intensity of the light beam as shown in FIGS. 3 through 5. FIG. 6 shows tube 22 disposed around the perimeter of guide 16.

Preferably, the cooling outlets 22 are disposed along the periphery of the light guide 16 as indicated in FIG. 8 so that the cooling fluid 40 is radiated on tissue 42, which is proximate the surface being cured 44, but not directly on surface 44 being cured. The cooling fluid is used to cool the surfaces in the mouth near the composite being cured that may be effected by the heat radiating from opening 17. By cooling the surrounding tissue, the cooling fluid relieves the effects of the heat produced by the intensity of the light beam during the curing process on surrounding tissue in the mouth.

The invention herein is not limited to a particular construction of the hose but may include alternate means for supplying cooling means such as gas or liquid to the surface to be cured. The source of the cooling mechanism may be included in housing 12, for example, in the form of compressive air, or it may be located outside the unit and thus connected to the curing unit. Preferably, the air or fluid is supplied internally in the form of a compressor. Typically, external sources available at the dentist office include air and water supplies connected, respectively, to an air syringe and a water spray. Accordingly, the curing unit may be designed to connect to an external air or water source at the office. The cooling fluid supplied at the dentist office is typically at room temperature or in the range of about 10 to about 30° C. The cooling fluid provided to or in the curing unit is at a temperature effective to cool or comfort the area proximate the surface being cured and may be in the range of about 10 to about 30° C. FIG. 1 shows an air valve 25 that is connectable to an external air source at the dentist office. The external air supply may be connected to inlet 26 via a hose or conduit 28. It is to be understood that the cooling medium is not limited to air and water and any known cooling medium may be used such as silicone oil.

A targeting light 30 may be included in curing unit 10 and focused on the end of light guide 16. Targeting light 30 may be any known lamp source such as a laser, LED, incandescent lamp or the like which is used to focus light guide 16 on the site to be cured prior to initiating light source 14. Accordingly, the operator will know exactly where the light guide is focused for accurate targeting and efficient curing/whitening. This will increase efficiency and save time that would otherwise be lost trying to focus the light beam at the onset of the operation.

The curing unit may include a variety of curing, whitening and cooling modes. A switch or button is preferably included on the light guide near outlet end 16A to enable the operator to easily access and operate the unit. The cooling mode may automatically be included in the curing and whitening modes or made be accessed independently of the curing and whitening modes. The curing unit provides a facile system for performing curing and cooling functions simultaneously and/or whitening and cooling functions simultaneously with a single instrument.

The curing unit may include a fluid flow dectector to determine if the cooling fluid is flowing through tube 22 to outlet 22A. This is important to prevent excessive heating in the area proximate the surface being cured. A fluid flow sensor may be placed anywhere on tube 22. FIG. 1 shows a fluid flow sensor 32 positioned on tube 22 inside housing 12. The sensor may be any known sensor device such as a thermal mass sensor, a turbine flow sensor or a pressure sensor.

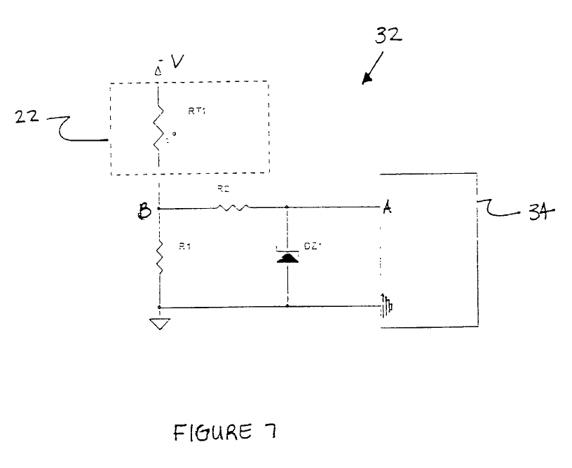

FIG. 7 shows a preferred embodiment of the invention showing a sensor circuit diagram for fluid flow sensor 32. Fluid flow sensor 32 is connected to microcontroller 34 at A which measures the voltage at B. Microcontroller 34 is part of the control circuit 20 in FIG. 1. It has a channel on the input of the analog to digital (A/D) peripheral subsystem. This channel is used as part of the fluid flow sensor circuit.

Sensor 32 is coupled to tube 22 via a thermistor RT1 which is preferably a positive temperature coefficient (PTC) thermistor and which is positioned within tube 22. A resistor R1 is connected to thermistor RT1 at point B. RT1 is used as the main component in detecting air flow. When voltage V is applied to the PTC, current flows and heat is generated causing the resistance of the PTC to increase. The increase in resistance lowers the current. R1 is used to measure the current by measuring the voltage across the series resistance R1. This voltage is the input to the analog to digital A/D converter in microcontroller 34.

A resistor R2 and a xener diode DZ1 are included in the fluid sensor circuit. The thermistor is positioned in tube 22 so that fluid flow will cool the surfaces of the PTC. Preferably, themistor RT1 is located in an insertion tube such as a Tee or Y which is inserted into tube 22. The cooling fluid enters one side of tube 22 and flows past the PTC and continues through tube 22 to the outlet 22A.

When cooling fluid is not flowing, the PTC will self heat to a temperature dependent on the voltage applied. The PTC will reach a somewhat stable temperature. The PTC is selected with a transition temperature that will allow the resistance to increase, due to self heating, to a temperature that is suitable for the material of tube 22 in which it is mounted, and which will cause a significant change in current to flow. When the cooling fluid supply is turned on, the fluid cools the PTC, the resistance of the PTC drops significantly causing a higher voltage drop across the series resistor. This voltage change is measured by the microcontroller and compared to a predetermined level to detect fluid flow. The zener diode and R2 resistor are used to protect the input to the A/D of the microcontroller.

This system allows for self tests. If the PTC becomes damaged or disconnected, no current will flow. This can be measured by the microcontroller A/D. If the PTC shorts out, this can also be detected by the A/D.

The sensor can be programmed such that if no fluid flow is detected, an alert mechanism is triggered, such as an alarm, or alternatively, the system may automatically shut down. Depending on the type of cooling fluid used, the thermistor which is in contact with the fluid may be coated with a protective layer of material. For example, the thermistor may be used with air, but may need a layer of protective coating if water is the cooling fluid utilized.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A curing unit comprising:
a light source;
a light guide connected to the light source for guiding light to a material to be cured;
a conduit for supplying cooling fluid proximate the material to be cured; and
a fluid flow sensor;
wherein the fluid is directed proximate the material to be cured to relieve the effects of the heat produced by the intensity of the light beam during the curing process on surrounding tissue in the mouth and for cooling the tissue;
wherein the fluid is selected from the group consisting of water and air.

2. The curing unit of claim 1 further comprising a supply of fluid connected to the conduit for supplying fluid.

3. The curing unit of claim 1 wherein the fluid is in the temperature range of from about 10 to about 30° C.

4. The curing unit of claim 1 wherein the conduit for supplying fluid is connected to an external fluid supply.

5. The curing unit of claim 1 wherein the material is a photoactivated material located in a person's mouth.

6. The unit of claim 1 wherein the materials comprise light curable resin composites.

7. The curing unit of claim 1 further comprising:
a second light source.

8. The curing unit of claim 1 wherein the second light source targets the surface for the first light source.

9. The curing unit of claim 1 wherein the light source and cooling fluid exit from a single unit.

10. The curing unit of claim 1 wherein the fluid flow sensor comprises a thermistor for detecting fluid flow.

11. The curing unit of claim 10 wherein the fluid flow sensor further comprises:
a series resistor;
a second resistor;
a zener diode;
an A/D converter; and
a microprocessor.

12. The curing unit of claim 10 wherein the thermistor is a positive temperature coefficient (PTC) thermistor.

13. The curing unit of claim 10 wherein the thermistor is located in the conduit.

14. The curing unit of claim 1 further comprising an alarm wherein the alarm is connected to the fluid flow sensor, and wherein the alarm will sound if no fluid flow is detected during operation of the unit.

15. The curing unit of claim 1 wherein the conduit for supplying fluid is connected to an internal fluid supply.

16. The curing unit of claim 1 wherein the light source will shut off if no fluid flow is detected by the fluid flow sensor.

17. A method of curing dental materials comprising:
directing a light source at the material to be cured;
simultaneously directing a cooling fluid in the direction of tissue proximate the material to be cured;
curing the material to be cured.

18. The method of claim 17 wherein the light source and cooling fluid exit from a single unit.

19. The method of claim 17 further comprising directing a target light source onto the material to be cured prior to curing the material.
